(19) United States
(12) Patent Application Publication
(10) Pub. No.: US 2010/0134254 A1
(43) Pub. Date: Jun. 3, 2010

(54) Chip-less radio frequency identification systems using metamaterials and identification methods thereof

(75) Inventor: Seon O. Kim, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/591,255

(22) Filed: Nov. 13, 2009

(30) Foreign Application Priority Data
Dec. 3, 2008 (KR) 10-2008-0121995

(51) Int. Cl. H04Q 5/22

(52) U.S. Cl. 340/10.1

(57) ABSTRACT

A chip-less RFID system, using metamaterial, may include a tag and a reader. The tag may include the metamaterial. The metamaterial may have at least two resonance frequencies. The reader may change a frequency of a first electromagnetic wave to be transmitted to the tag. The reader may recognize an identification (ID) of the tag by receiving a second electromagnetic wave from the tag that corresponds to the first electromagnetic wave. An identification method of chip-less RFID systems, using metamaterial, may include creating a tag that includes the metamaterial, the metamaterial having different resonance frequencies, changing a frequency of a first electromagnetic wave to be transmitted to the tag by a reader, and analyzing a frequency spectrum of a second electromagnetic wave from the tag that corresponds to the first electromagnetic wave.

### CROSS-REFERENCE TO RELATED APPLICATION(S)

This application claims priority from Korean Patent Application No. 2008-0121995, filed on Dec. 3, 2008, in the Korean Intellectual Property Office (KIPO), the entire contents of which are incorporated herein by reference.

### BACKGROUND

1. Field

Example embodiments relate to chip-less radio frequency identification (RFID) systems using metamaterials and/or identification methods thereof. Also, example embodiments relate to chip-less RFID systems using metamaterials that are capable of adjusting resonance frequencies by changing the form of the metamaterials and/or identification methods thereof.

2. Description of the Related Art

Generally, an RFID system may be a system developed to recognize an object in a non-contact fashion in order to make up for defects of recognition systems that use barcodes and/or magnetic cards. An RFID system may include computers that read information using tags and readers, and that process data read by the readers.

The readers may transmit electromagnetic waves to the tags, may receive response electromagnetic waves from the tags, and/or may process and/or store signals. The tags may contain information regarding objects to which they may be attached.

RFID systems may have been widely applied to various fields as a recognition technology expected to substitute for conventional barcode systems. For example, RFID systems may be used to perform process management in order to modify or discard defective products through the recording of the defective products in an industrial field, or to perform entrance management in order to allow entrance based on readers installed at places necessary for entrance control. Also, RFID systems may be used to perform parking management in order to manage vehicles entering and/or leaving parking lots in public fields and/or to perform library management to catch hold of lending and/or returning books and/or to manage the existing states of books. Furthermore, RFID systems may be used to perform electronic payments in order to electrically make payment in financial fields. In addition, RFID systems may be used in various living-related fields.

Tags may be classified as a chip-type tag or a chip-less-type tag. Based on whether a tag has its own power supply, the tag may be classified as an active tag, a passive tag, or a battery-assisted passive (BAP) tag.

Active tags with a chip may have an advantage in that the active tag has may have capacity to store information and/or may be recognized at a long distance. BAP tags, that may require an external source to “wake up”, may have longer battery life than active tags. However, manufacturing costs of active tags and/or BAP tags may be high. Passive tags may be activated by energy from electromagnetic waves received by the passive tags. Passive tags may be manufactured at relatively low costs.

Chip-less tag technology using surface acoustic waves (SAW) as a passive tag may generate surface acoustic waves by mounting an interdigit transducer (IDT) having metal thin film electrodes repeatedly disposed at the surface of a piezoelectric material, and/or using a reverse piezoelectric effect and/or a direct piezoelectric effect of the piezoelectric material.

Despite the development of such tag technology, it may be required to use a medium to detect electromagnetic waves, with the result that manufacturing costs of the tags may still be high as compared with a recognition system using barcodes printable on paper. For this reason, it may be desired for a measure to reduce manufacturing costs of the tags such that commercially-viable use of the tags may be achieved.

### SUMMARY

Example embodiments may provide a chip-less RFID system that may be capable of setting a tag ID using metamaterial having different resonance frequencies. Example embodiments may enable the manufacture of inexpensive tags. Example embodiments also may provide identification methods using metamaterials.

According to example embodiments, a chip-less RFID system using metamaterial may include a tag with metamaterial having at least two resonance frequencies and/or a reader to change a frequency of an electromagnetic wave to be transmitted to the tag and/or to recognize a tag ID of the tag by receiving a response electromagnetic wave corresponding to the electromagnetic wave having the changed frequency.

The tag may adjust the resonance frequencies of the metamaterial by changing a form of the metamaterial.

The resonance frequencies of the metamaterial may be set in response to the tag ID assigned to the tag.

The metamaterial may be manufactured, for example, by printing conductive ink on paper. The printing may use an inkjet printing technology.

The metamaterial may be manufactured by cutting a metal thin film with a laser beam according to the form of the metamaterial.

The metamaterial may be manufactured by forming a pattern according to a printed circuit board manufacturing process and/or removing an unnecessary portion or portions from the pattern with a laser beam according to the form of the metamaterial.

The metamaterial may be manufactured by forming a pattern according to a printed circuit board manufacturing process and/or interconnecting cut-off portions of the pattern with a zero-ohm resistor according to the form of the metamaterial.

According to example embodiments, a chip-less RFID system using a metamaterial may include a tag having a metamaterial corresponding to an tag ID thereof, a reader to transmit an electromagnetic wave to the tag and recognize the tag ID of the tag by analyzing a frequency spectrum of an electromagnetic wave received as a result of the response of the metamaterial, a computer to store the tag ID received from the reader and transmit the tag ID via a network, and/or a server to receive the tag ID via the network.

The server may construct a database based on the tag ID in order to collect and/or administrate the tag recognized by the reader.

The number of the resonance frequencies set with respect to the metamaterial may be increased by enhancing a resolution of the tag ID of the tag.

The metamaterial may have its own resonance frequency to respond to an electromagnetic wave transmitted by the reader.

According to example embodiments, an identification method of a chip-less RFID system using a metamaterial may include creating a tag with a metamaterial having different resonance frequencies, changing a frequency of an electromagnetic wave to be transmitted to the tag by a reader, and/or analyzing a frequency spectrum of a response electromagnetic wave corresponding to the electromagnetic wave having the changed frequency to recognize a tag ID of the tag.

The resonance frequencies of the metamaterial may be adjusted by changing a form of the metamaterial.

The metamaterial may be manufactured by printing conductive ink on paper.

The metamaterial may be manufactured by cutting metal thin film with a laser beam according to a form of the metamaterial.

The metamaterial may be manufactured by forming a pattern according to a printed circuit board manufacturing process and/or removing an unnecessary portion or portions from the pattern with a laser beam according to a form of the metamaterial.

The metamaterial may be manufactured by forming a pattern according to a printed circuit board manufacturing process and interconnecting cut-off portions of the pattern with a zero-ohm resistor according to a form of the metamaterial.

The analyzing of the frequency spectrum may be performed using binary data set according to the resonance frequency of the electromagnetic wave received by the reader.

The identification method may further include storing the tag ID recognized by the reader, transmitting the recognized tag ID to a server via a network, and/or constructing a database based on the tag ID in order for the server to collect and/or administrate the tag.

According to example embodiments, a chip-less RFID system, using metamaterial, may comprise a tag and/or a reader. The tag may include the metamaterial. The metamaterial may have at least two resonance frequencies. The reader may change a frequency of a first electromagnetic wave to be transmitted to the tag. The reader may recognize an identification (ID) of the tag by receiving a second electromagnetic wave from the tag that corresponds to the first electromagnetic wave.

The first electromagnetic wave may be, for example, a microwave. The second electromagnetic wave may be, for example, a microwave. The first electromagnetic wave may have, for example, a frequency greater than or equal to about 300 MHz and less than or equal to about 300 GHz. The second electromagnetic wave may have, for example, a frequency greater than or equal to about 300 MHz and less than or equal to about 300 GHz. The first electromagnetic wave may have, for example, a frequency greater than or equal to about 1 GHz and less than or equal to about 100 GHz. The second electromagnetic wave may have, for example, a frequency greater than or equal to about 1 GHz and less than or equal to about 100 GHz.

According to example embodiments, a chip-less RFID system, using metamaterial, may comprise a tag, a reader, a computer, and/or a server. The tag may include the metamaterial. The metamaterial may correspond to an ID of the tag. The reader may transmit a first electromagnetic wave to the tag. The reader may recognize the tag ID by analyzing a frequency spectrum of a second electromagnetic wave received from the tag as a result of a response of the metamaterial to the first electromagnetic wave. The computer may store the tag ID received from the reader and/or may transmit the tag ID via a network. The server may receive the tag ID via the network.

The first electromagnetic wave may be, for example, a microwave. The second electromagnetic wave may be, for example, a microwave. The first electromagnetic wave may have, for example, a frequency greater than or equal to about 300 MHz and less than or equal to about 300 GHz. The second electromagnetic wave may have, for example, a frequency greater than or equal to about 300 MHz and less than or equal to about 300 GHz. The first electromagnetic wave may have, for example, a frequency greater than or equal to about 1 GHz and less than or equal to about 100 GHz. The second electromagnetic wave may have, for example, a frequency greater than or equal to about 1 GHz and less than or equal to about 100 GHz.

According to example embodiments, an identification method of chip-less radio frequency identification (RFID) systems, using metamaterial, may comprise creating a tag that includes the metamaterial, the metamaterial having different resonance frequencies; changing a frequency of a first electromagnetic wave to be transmitted to the tag by a reader; and analyzing a frequency spectrum of a second electromagnetic wave from the tag that corresponds to the first electromagnetic wave.

The first electromagnetic wave may be, for example, a microwave. The second electromagnetic wave may be, for example, a microwave. The first electromagnetic wave may have, for example, a frequency greater than or equal to about 300 MHz and less than or equal to about 300 GHz. The second electromagnetic wave may have, for example, a frequency greater than or equal to about 300 MHz and less than or equal to about 300 GHz. The first electromagnetic wave may have, for example, a frequency greater than or equal to about 1 GHz and less than or equal to about 100 GHz. The second electromagnetic wave may have, for example, a frequency greater than or equal to about 1 GHz and less than or equal to about 100 GHz.

### BRIEF DESCRIPTION OF THE DRAWINGS

The above and/or other aspects and advantages will become apparent and more readily appreciated from the following description of example embodiments, taken in conjunction with the accompanying drawings, in which:

FIG. 1 is a block diagram illustrating a chip-less RFID system using a metamaterial according to example embodiments;

FIG. 2A is a view illustrating the transmission and reception of electromagnetic waves between a reader and a tag of FIG. 1;

FIG. 2B is a view illustrating a tag according to example embodiments;

FIG. 3 is a graph illustrating a frequency spectrum of an electromagnetic wave received when the frequency of the electromagnetic wave transmitted is changed in a reader according to example embodiments;

FIG. 4 is a view illustrating a process for manufacturing metamaterial regions on metal thin film using a laser beam according to example embodiments;

FIG. 5 is a view illustrating the manufacture of metamaterial regions on a printed circuit board according to example embodiments;

FIG. 6 is a view illustrating the manufacture of a metamaterial region on a printed circuit board using one or more zero-ohm resistors according to example embodiments; and

FIG. 7 is a flow chart illustrating a recognition method of a chip-less RFID system using metamaterial according to example embodiments.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

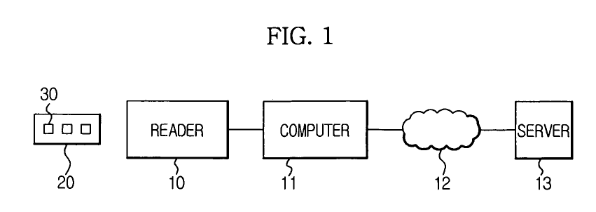

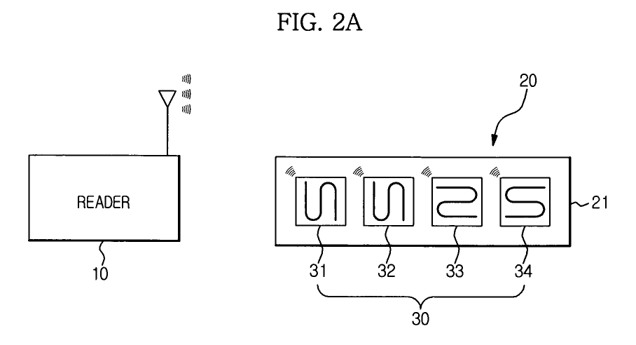

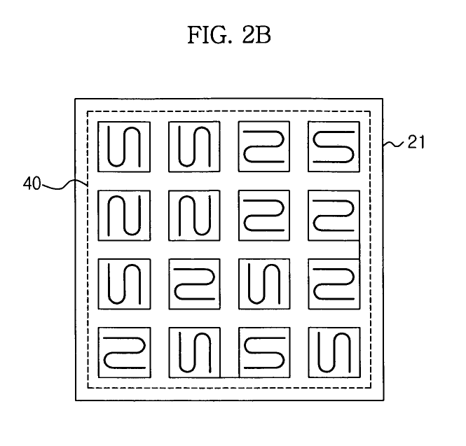

FIG. 1 is a block diagram illustrating a chip-less RFID system using a metamaterial according to example embodiments. FIG. 2A is a view illustrating the transmission and reception of electromagnetic waves between a reader and a tag of FIG. 1. FIG. 2B is a view illustrating a tag according to example embodiments.

As shown, a chip-less RFID system may include tag 20, reader 10, computer 11, network 12, and/or server 13.

Reader 10 may transmit an electromagnetic wave to tag 20, which has metamaterial 30, and may receive a response electromagnetic wave from tag 20. Reader 10 may analyze the frequency spectrum of the received electromagnetic wave to recognize a tag ID assigned to tag 20.

The transmitted electromagnetic wave may be, for example, a microwave. The received electromagnetic wave may be, for example, a microwave. The transmitted electromagnetic wave may have, for example, a frequency greater than or equal to about 300 MHz and less than or equal to about 300 GHz. The received electromagnetic wave may have, for example, a frequency greater than or equal to about 300 MHz and less than or equal to about 300 GHz. The transmitted electromagnetic wave may have, for example, a frequency greater than or equal to about 1 GHz and less than or equal to about 100 GHz. The received electromagnetic wave may have, for example, a frequency greater than or equal to about 1 GHz and less than or equal to about 100 GHz.

Computer 11 may be connected to reader 10 in order to store data related to the recognized tag ID. For example, reader 10 may have a function to recognize the tag ID, but may not have a function to store the tag ID due to the lack of a memory. This may be because it is possible to apply a procedure to process the recognized tag ID by connecting a compatible reader to a generally available computer and, thus, to lower the manufacturing costs of the reader. In example embodiments, the reader may not be particularly restricted in performing a procedure to store the recognized tag ID. Furthermore, the reader may not be particularly restricted in analyzing and/or processing the recognized tag ID. Additions and/or changes in function of the reader at this level may be permissible.

Computer 11 may be connected to server 13 via network 12.

Server 13 may collect the tag ID of the tag provided by the computer-11 via network 12 in order to construct a database. The constructed database may be variously utilized depending upon the use environment and/or purpose of the RFID system. For example, server 13 may provide a web site opened on the Internet in order to allow retrieving and/or reading of the database.

A server administrator may understand the collection and/or the existing state of the tag ID recognized through reader 10 in a remote fashion.

Referring to FIG. 2A, metamaterial 30 of tag 20 may include a plurality of metamaterial regions 31, 32, 33, and 34 arranged on paper 21. The arrangement may be, for example, linear.

In example embodiments, metamaterial 30 may include first metamaterial region 31, second metamaterial region 32, third metamaterial region 33, and/or fourth metamaterial region 34. However, the number and/or arrangement of the metamaterial regions may be changed as needed by a person having an ordinary skill in the art (PHOSITA). For example, a plurality of metamaterial regions 40 having different forms may be arranged on paper 21, up and down, side to side, or in one or more of many other arrangements.

Metamaterials may be materials artificially designed to exhibit one or more special electromagnetic properties that cannot be found generally in nature. For example, it may be possible to adjust the permittivity and/or permeability of the metamaterial by changing the form of the metamaterial. Depending upon the form of the metamaterial, for example, the respective metamaterial regions may have their own resonance frequencies.

In example embodiments, a plurality of metamaterial regions may be manufactured by printing conductive ink on paper using inkjet printing technology. When changing the form of metamaterial regions 31, 32, 33, and 34, first metamaterial region 31 may have first resonance frequency f1, second metamaterial region 32 may have second resonance frequency f2, third metamaterial region 33 may have third resonance frequency f3, and/or fourth metamaterial region 34 may have fourth resonance frequency f4. The conductive ink may comprise, for example, a silver solution. In addition, any conductive material exhibiting properties associated with metamaterials may be used as the conductive ink.

When reader 10 transmits a first electromagnetic wave, the metamaterial regions 31, 32, 33, and 34 may selectively respond to the first electromagnetic wave based on their own resonance frequencies and/or may transmit a second response electromagnetic wave. For example, when the electromagnetic wave transmitted by reader 10 has a frequency corresponding to third metamaterial region 33 having third resonance frequency f3, only metamaterial region 33 may respond to the electromagnetic wave. Thus, only metamaterial region 33 may transmit a response electromagnetic wave. The remaining three metamaterial regions 31, 32, and 34, having different resonance frequencies, may not respond to the electromagnetic wave (and may transmit no response electromagnetic wave). Reader 10 may receive the second electromagnetic wave corresponding to third resonance frequency f3. Reader 10 may recognize that metamaterial region 33 exists on paper 21 of tag 20.

The transmitted electromagnetic wave may be, for example, a microwave. The received electromagnetic wave may be, for example, a microwave. The transmitted electromagnetic wave may have, for example, a frequency greater than or equal to about 300 MHz and less than or equal to about 300 GHz. The received electromagnetic wave may have, for example, a frequency greater than or equal to about 300 MHz and less than or equal to about 300 GHz. The transmitted electromagnetic wave may have, for example, a frequency greater than or equal to about 1 GHz and less than or equal to about 100 GHz. The received electromagnetic wave may have, for example, a frequency greater than or equal to about 1 GHz and less than or equal to about 100 GHz.

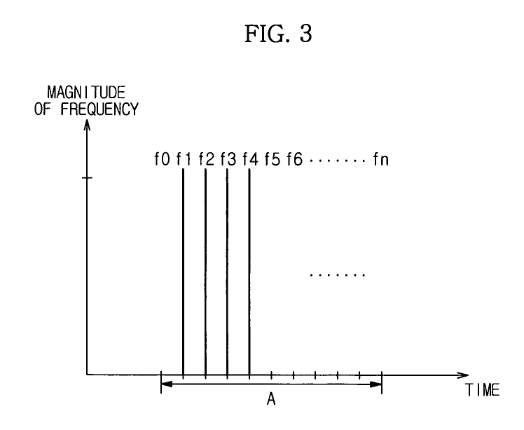

FIG. 3 is a graph illustrating a frequency spectrum of an electromagnetic wave received when the frequency of the electromagnetic wave transmitted is changed in a reader according to example embodiments.

Referring to FIG. 3, when reader 10 transmits an electromagnetic wave while sequentially changing the frequency of the electromagnetic wave within a frequency range f0, f1 . . . fn (the frequency range may or may not be predetermined) for a time A (the time may or may not be predetermined), metamaterial regions 31, 32, 33, and 34 may individually respond to the electromagnetic wave having their own resonance frequencies and/or may generate a response electromagnetic wave. For example, reader 10, receiving the electromagnetic wave generated by the individual response of the metamaterial regions 31, 32, 33, and 34, may analyze the resonance frequencies of the received electromagnetic wave and/or may express whether the electromagnetic wave exists for each frequency as binary data. For example, on the assumption that ‘1’ is assigned to a response frequency within the frequency range f0, f1, . . . , fn, and ‘0’ is assigned to a non-response frequency, ‘01111000 . . . ’ may be obtained from the frequency spectrum. This binary data may be recognized as the tag ID of multiple tag 20.

The transmitted electromagnetic wave may be, for example, a microwave. The received electromagnetic wave may be, for example, a microwave. The transmitted electromagnetic wave may have, for example, a frequency greater than or equal to about 300 MHz and less than or equal to about 300 GHz. The received electromagnetic wave may have, for example, a frequency greater than or equal to about 300 MHz and less than or equal to about 300 GHz. The transmitted electromagnetic wave may have, for example, a frequency greater than or equal to about 1 GHz and less than or equal to about 100 GHz. The received electromagnetic wave may have, for example, a frequency greater than or equal to about 1 GHz and less than or equal to about 100 GHz.

The combination of metamaterial regions having different resonance frequencies to express binary data as described above may support a coding procedure. The tag ID may be assigned through the coding procedure and, therefore, the combination of metamaterial regions may be a kind of code.

Also, the greater the number of bits of binary data, the higher the resolution may be. For example, the number of metamaterial regions may be increased to enhance resolution.

In example embodiments, the method of forming the metamaterial regions of conductive ink on paper using ink jet technology may be substituted or supplemented by other methods to manufacture metamaterial regions having different resonance frequencies.

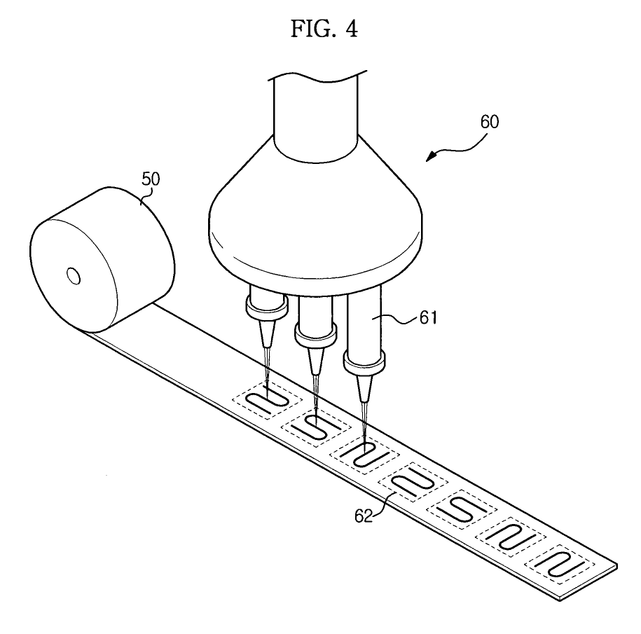

FIG. 4 is a view illustrating a process for manufacturing metamaterial regions on metal thin film using a laser beam according to example embodiments.

As shown, metal thin film 50 may be conveyed by a conveyor (not shown). The metal thin film may be cut by a laser beam emitted from laser emitter 61 mounted in metamaterial creation apparatus 60 in order to form a pattern, thereby manufacturing metamaterial regions 62 having a form of a metamaterial. For example, may be possible to inexpensively manufacture various kinds of metamaterial regions having their own resonance frequencies.

When making a tag by combining metamaterial regions according to a desired tag ID, it may be possible for the reader to recognize a tag to which the tag ID is assigned. That is, a method of changing the frequency of an electromagnetic wave by reader 10 and/or recognizing a tag ID based on binary data obtained by analyzing the resonance frequency of a received electromagnetic wave may be the same as in example embodiments.

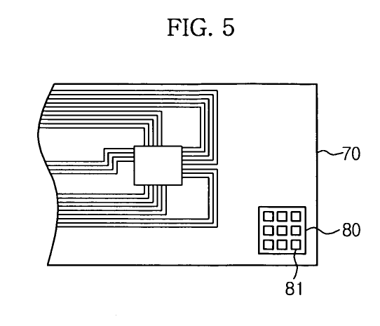

FIG. 5 is a view illustrating the manufacture of metamaterial regions on a printed circuit board according to example embodiments.

Generally, a printed circuit formed on printed circuit board 70 may be made of conductive material. The printed circuit may be processed according to a designed pattern.

In example embodiments, a pattern of conductive material may be formed on printed circuit board 70 according to a general process, and then one or more unnecessary portions may be removed from the pattern formed on the printed circuit board. The removal may use, for example, a laser beam emitted from a laser emitter. The removal may result in tag 80, including a plurality of metamaterial regions 81 having a form of a metamaterial. Metamaterial regions 81 formed in tag 80 may have their own resonance frequencies. Consequently, reader 10 may change the frequency of an electromagnetic wave, may transmit the electromagnetic wave to tag 80, may receive a response electromagnetic wave corresponding to one of the metamaterial regions formed in the tag, and/or may recognize a tag ID of tag 80 based on binary data obtained by analyzing the resonance frequency of the received electromagnetic wave.

The transmitted electromagnetic wave may be, for example, a microwave. The received electromagnetic wave may be, for example, a microwave. The transmitted electromagnetic wave may have, for example, a frequency greater than or equal to about 300 MHz and less than or equal to about 300 GHz. The received electromagnetic wave may have, for example, a frequency greater than or equal to about 300 MHz and less than or equal to about 300 GHz. The transmitted electromagnetic wave may have, for example, a frequency greater than or equal to about 1 GHz and less than or equal to about 100 GHz. The received electromagnetic wave may have, for example, a frequency greater than or equal to about 1 GHz and less than or equal to about 100 GHz.

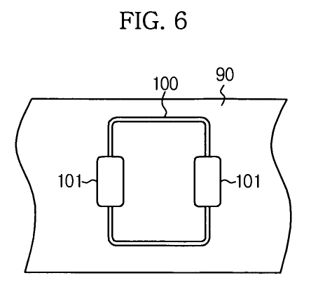

FIG. 6 is a view illustrating the manufacture of a metamaterial region on a printed circuit board using one or more zero-ohm resistors according to example embodiments. Example embodiments of FIG. 6 may be modifications of example embodiments of FIG. 5.

In example embodiments, pattern 100 constituting metamaterial 90 may be formed according to a general process to manufacture the printed circuit board, and then the form of pattern 100 may be modified using the one or more zero-ohm resistors. That is, cut-off portions of the pattern may be interconnected in order to modify the form of the pattern.

As known to a PHOSITA, zero-ohm resistors may be, for example, wire links used to connect traces on printed circuit boards. The wire links may be packaged in a similar form to a resistor. The actual resistance of a zero-ohm resistor is not 0 ohms, but is approximately 0 ohms. A maximum value, such as 25 milli-ohms, may be specified.

The resultant metamaterial may have its own resonance frequency. Consequently, when making a tag by combining metamaterial regions according to a desired tag ID, it may be possible for the reader to recognize a tag to which the tag ID is assigned. That is, a method of changing the frequency of an electromagnetic wave by reader 10 and/or of recognizing a tag ID based on binary data obtained by analyzing the resonance frequency of a received electromagnetic wave may be the same as the previous embodiment.

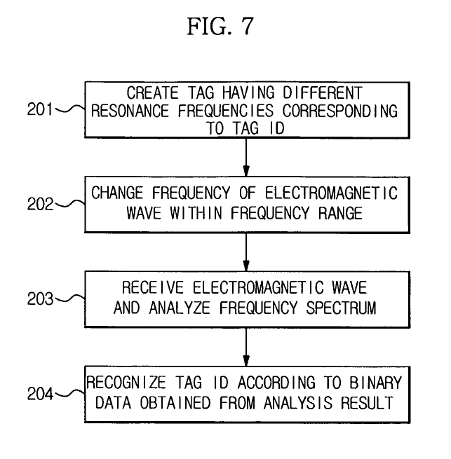

FIG. 7 is a flow chart illustrating a recognition method of a chip-less RFID system using metamaterial according to example embodiments.

First, a plurality of metamaterial regions having their own resonance frequencies may be arranged according to a tag ID to create a tag (201). The metamaterial regions may be manufactured by manufacturing methods according to one or more of the example embodiments.

Subsequently, reader 10 may transmit an electromagnetic wave to the tag and/or may change the frequency of the electromagnetic wave within a frequency range A, that may or may not be predetermined (202). The transmitted electromagnetic wave may be, for example, a microwave. The transmitted electromagnetic wave may have, for example, a frequency greater than or equal to about 300 MHz and less than or equal to about 300 GHz. The transmitted electromagnetic wave may have, for example, a frequency greater than or equal to about 1 GHz and less than or equal to about 100 GHz.

The metamaterial regions existing in tag 20 may individually respond to the electromagnetic wave based on their own resonance frequency, and/or may transmit a response electromagnetic wave having the corresponding resonance frequency to reader 10. Reader 10 may receive the response electromagnetic wave and/or may analyze the frequency spectrum of the frequency of the received electromagnetic wave (203). Finally, reader 10 may recognize a tag ID of the tag according to binary data obtained from the analysis result (204). The received electromagnetic wave may be, for example, a microwave. The received electromagnetic wave may have, for example, a frequency greater than or equal to about 300 MHz and less than or equal to about 300 GHz. The received electromagnetic wave may have, for example, a frequency greater than or equal to about 1 GHz and less than or equal to about 100 GHz.

Example embodiments may be capable of setting a tag ID using a plurality of metamaterial regions responding to their resonance frequencies decided according to the form of a metamaterial and/or manufacturing a tag having the metamaterial regions with low costs. Consequently, example embodiments may have the effect of using an inexpensive tag, thereby reducing an economical burden and/or expanding the use scope of the tag.

While example embodiments have been particularly shown and described, it will be understood by those of ordinary skill in the art that various changes in form and details may be made therein without departing from the spirit and scope of the present invention as defined by the following claims.

What is claimed is:

1. A chip-less radio frequency identification (RFID) system using metamaterial, the system comprising:
a tag that includes the metamaterial, the metamaterial having at least two resonance frequencies; and
a reader that changes a frequency of a first electromagnetic wave to be transmitted to the tag and that recognizes an identification (ID) of the tag by receiving a second electromagnetic wave from the tag that corresponds to the first electromagnetic wave.

2. The chip-less RFID system of claim 1, wherein the tag adjusts the resonance frequencies of the metamaterial by changing a form of the metamaterial.

3. The chip-less RFID system of claim 1, wherein the resonance frequencies of the metamaterial are set in response to the tag ID assigned to the tag.

4. The chip-less RFID system of claim 1, wherein the metamaterial is manufactured by printing conductive ink on paper using inkjet printing technology.

5. The chip-less RFID system of claim 1, wherein the metamaterial is manufactured by cutting metal thin film with a laser beam according to a form of the metamaterial.

6. The chip-less RFID system of claim 1, wherein the metamaterial is manufactured by forming a pattern according to a printed circuit board manufacturing process and removing an unnecessary portion or portions from the pattern with a laser beam according to a form of the metamaterial.

7. The chip-less RFID system of claim 1, wherein the metamaterial is manufactured by forming a pattern according to a printed circuit board manufacturing process and interconnecting cut-off portions of the pattern with one or more zero-ohm resistors according to a form of the metamaterial.

8. A chip-less radio frequency identification (RFID) system using metamaterial, the system comprising:
a tag that includes the metamaterial, the metamaterial corresponding to an identification (ID) of the tag;
a reader that transmits a first electromagnetic wave to the tag and that recognizes the tag ID by analyzing a frequency spectrum of a second electromagnetic wave received from the tag as a result of a response of the metamaterial to the first electromagnetic wave;
a computer that stores the tag ID received from the reader and that transmits the tag ID via a network; and
a server to receive the tag ID via the network.

9. The chip-less RFID system of claim 8, wherein the server constructs a database based on the tag ID in order to collect and administrate the tag recognized by the reader.

10. The chip-less RFID system of claim 8, wherein a number of the resonance frequencies set with respect to the metamaterial is increased by enhancing a resolution of the tag ID.

11. The chip-less RFID system of claim 8, wherein the metamaterial has its own resonance frequency in order to respond to the first electromagnetic wave.

12. An identification method of chip-less radio frequency identification (RFID) systems using metamaterial, the identification method comprising:
creating a tag that includes the metamaterial, the metamaterial having different resonance frequencies;
changing a frequency of a first electromagnetic wave to be transmitted to the tag by a reader; and
analyzing a frequency spectrum of a second electromagnetic wave from the tag that corresponds to the first electromagnetic wave.

13. The identification method of claim 12, wherein the resonance frequencies of the metamaterial are adjusted by changing a form of the metamaterial.

14. The identification method of claim 12, wherein the metamaterial is manufactured by printing conductive ink on paper.

15. The identification method of claim 12, wherein the metamaterial is manufactured by printing conductive ink on paper using inkjet printing technology.

16. The identification method of claim 12, wherein the metamaterial is manufactured by cutting a metal thin film with a laser beam according to a form of the metamaterial.

17. The identification method of claim 12, wherein the metamaterial is manufactured by forming a pattern according to a printed circuit board manufacturing process and removing an unnecessary portion or portions from the pattern with a laser beam according to a form of the metamaterial.

18. The identification method of claim 12, wherein the metamaterial is manufactured by forming a pattern according to a printed circuit board manufacturing process and interconnecting cut-off portions of the pattern with one or more zero-ohm resistors according to a form of the metamaterial.

19. The identification method of claim 12, wherein analyzing the frequency spectrum is performed using binary data set according to a frequency of the second electromagnetic wave.

20. The identification method of claim 12, further comprising:
storing an identification (ID) of the tag recognized by the reader;
transmitting the recognized tag ID to a server via a network; and
constructing a database based on the tag ID in order for the server to collect and administrate the tag recognized by the reader.
